(19) United States
(12) Patent Application Publication
(10) Pub. No.: US 2021/0376461 A1
(43) Pub. Date: Dec. 2, 2021

(54) HYBRID PHASED-ARRAY AND STEERING LENSES FOR BEAM STEERING

(71) Applicant: QUALCOMM Incorporated, San Diego, CA (US)

(72) Inventors: Yehonatan DALLAL, Kfar Saba (IL); Idan Michael HORN, Hod Hasharon (IL); Shay LANDIS, Hod Hasharon (IL)

(21) Appl. No.: 17/303,441

(22) Filed: May 28, 2021

Related U.S. Application Data
(60) Provisional application No. 63/032,926, filed on Jun. 1, 2020.

(51) Int. Cl. H01Q 3/18; H01Q 3/24; H01Q 3/46; H01Q 3/26

(52) U.S. Cl. CPC H01Q 3/18; H01Q 3/2641; H01Q 3/46; H01Q 3/247

(57) ABSTRACT

Various aspects of the present disclosure generally relate to wireless communication. In some aspects, a wireless communication device may select, for communicating a signal, one or more active elements of a set of antenna elements based at least in part on positions of the one or more active elements of the set of antenna elements relative to a set of steering lenses of the wireless communication device; and communicate the signal based at least in part on emitting or receiving the signal using the one or more active elements, wherein the set of steering lenses of the wireless communication device steer the signal to or from the one or more active elements. Numerous other aspects are provided.

### CROSS-REFERENCE TO RELATED APPLICATION

This Patent Application claims priority to Provisional Patent Application No. 63/032,926, filed on Jun. 1, 2020, entitled “HYBRID PHASED-ARRAY AND STEERING LENS FOR BEAM STEERING,” and assigned to the assignee hereof. The disclosure of the prior Application is considered part of and is incorporated by reference in this Patent Application.

### FIELD OF THE DISCLOSURE

Aspects of the present disclosure generally relate to wireless communication and to techniques and apparatuses for beam steering.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency-division multiple access (FDMA) systems, orthogonal frequency-division multiple access (OFDMA) systems, single-carrier frequency-division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include a number of base stations (BSs) that can support communication for a number of user equipment (UEs). A UE may communicate with a BS via the downlink and uplink. “Downlink” (or “forward link”) refers to the communication link from the BS to the UE, and “uplink” (or “reverse link”) refers to the communication link from the UE to the BS. As will be described in more detail herein, a BS may be referred to as a Node B, a gNB, an access point (AP), a radio head, a transmit receive point (TRP), a New Radio (NR) BS, a 5G Node B, or the like.

The above multiple access technologies have been adopted in various telecommunication standards to provide a common protocol that enables different user equipment to communicate on a municipal, national, regional, and even global level. NR, which may also be referred to as 5G, is a set of enhancements to the LTE mobile standard promulgated by the 3GPP. NR is designed to better support mobile broadband Internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink (DL), using CP-OFDM and/or SC-FDM (e.g., also known as discrete Fourier transform spread OFDM (DFT-s-OFDM)) on the uplink (UL), as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

In some aspects, a method of wireless communication performed by a wireless communication device includes selecting, for communicating a signal, one or more active elements of a set of antenna elements based at least in part on positions of the one or more active elements of the set of antenna elements relative to a set of steering lenses of the wireless communication device; and communicating the signal based at least in part on emitting or receiving the signal using the one or more active elements, wherein the set of steering lenses of the wireless communication device steer the signal to or from the one or more active elements.

In some aspects, a wireless communication device for wireless communication includes a set of antenna elements; a set of steering lenses; a memory; and one or more processors operatively coupled to the memory, the memory and the one or more processors configured to: select, for communicating a signal, one or more active elements of the set of antenna elements based at least in part on positions of the set of antenna elements relative to the set of steering lenses; and communicate the signal based at least in part on emitting or receiving the signal using the one or more active elements, wherein the set of steering lenses steers the signal to or from the one or more active elements.

In some aspects, a non-transitory computer-readable medium storing a set of instructions for wireless communication includes one or more instructions that, when executed by one or more processors of a wireless communication device, cause the wireless communication device to: select, for communicating a signal, one or more active elements of a set of antenna elements based at least in part on positions of the one or more active elements of the set of antenna elements relative to a set of steering lenses of the wireless communication device; and communicate the signal based at least in part on emitting or receiving the signal using the one or more active elements, wherein the set of steering lenses of the wireless communication device steer the signal to or from the one or more active elements.

In some aspects, an apparatus for wireless communication includes means for selecting, for communicating a signal, one or more active elements of a set of antenna elements based at least in part on positions of the one or more active elements of the set of antenna elements relative to a set of steering lenses of the apparatus; and means for communicating the signal based at least in part on emitting or receiving the signal using the one or more active elements, wherein the set of steering lenses of the apparatus steer the signal to or from the one or more active elements.

In some aspects, an apparatus for wireless communication includes an array of lenses; multiple pluralities of antenna elements, wherein a respective plurality of the multiple pluralities of antenna elements is aligned with each lens in the array of lenses; and transceiver circuitry configured to transmit or receive wireless signals through the array of lenses using at least a subset of antenna elements in each plurality of antenna elements.

Aspects generally include a method, apparatus, system, computer program product, non-transitory computer-readable medium, user equipment, base station, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, or artificial intelligence-enabled devices). Aspects may be implemented in chip-level components, modular components, non-modular components, non-chip-level components, device-level components, or system-level components. Devices incorporating described aspects and features may include additional components and features for implementation and practice of claimed and described aspects. For example, transmission and reception of wireless signals may include a number of components for analog and digital purposes (e.g., hardware components including antennas, radio frequency chains, power amplifiers, modulators, buffers, processor(s), interleavers, adders, or summers). It is intended that aspects described herein may be practiced in a wide variety of devices, components, systems, distributed arrangements, or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a base station in communication with a user equipment (UE) in a wireless network, in accordance with the present disclosure.

FIG. 3 is a diagram illustrating an example beamforming architecture that supports beamforming for millimeter wave communications or communications with a higher frequency, in accordance with the present disclosure.

FIG. 4 is a diagram illustrating an example associated with beam steering using a hybrid phased-array and steering lens, in accordance with the present disclosure.

FIGS. 5-10 are diagrams illustrating examples associated with a hybrid phased-array and steering lenses for beam steering, in accordance with the present disclosure.

FIG. 11 is a diagram illustrating an example process associated with beam steering using a hybrid phased-array and steering lens, in accordance with the present disclosure.

FIG. 12 is a diagram illustrating example power densities of signaling transmitted using a hybrid phased-array and steering lenses for beam steering, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein, one skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

It should be noted that while aspects may be described herein using terminology commonly associated with a 5G or NR radio access technology (RAT), aspects of the present disclosure can be applied to other RATs, such as a 3G RAT, a 4G RAT, a RAT subsequent to 5G (e.g., 6G), WiFi, and/or another RAT.

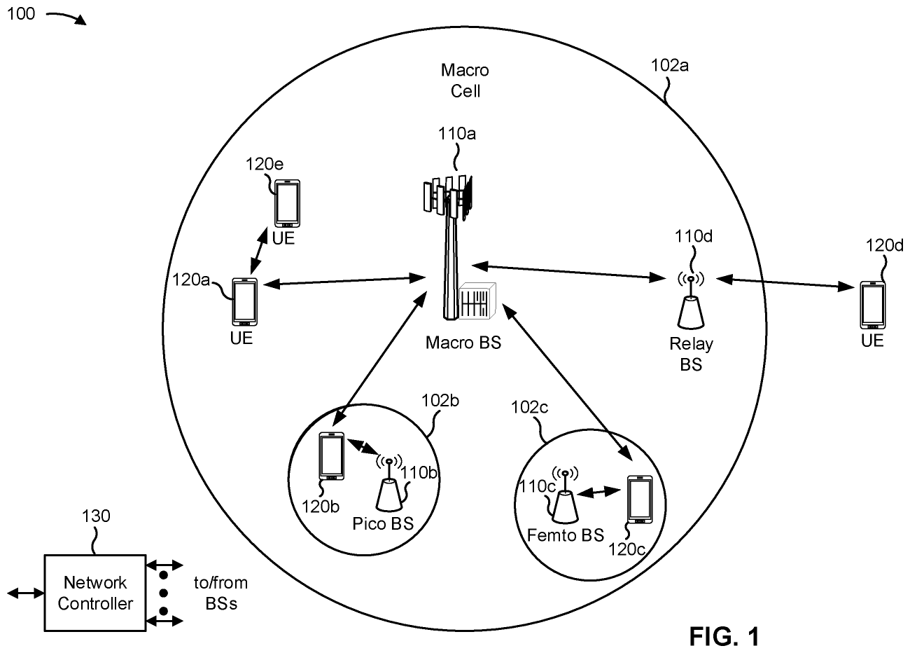

FIG. 1 is a diagram illustrating an example of a wireless network 100, in accordance with the present disclosure. The wireless network 100 may be or may include elements of a 5G (NR) network, an LTE network, and/or a WiFi network, among other examples. The wireless network 100 may include a number of base stations 110 (shown as BS 110a, BS 110b, BS 110c, and BS 110d) and other network entities. A base station (BS) is an entity that communicates with user equipment (UEs) and may also be referred to as an NR BS, a Node B, a gNB, a 5G node B (NB), an access point, a transmit receive point (TRP), or the like. Each BS may provide communication coverage for a particular geographic area. In 3GPP, the term “cell” can refer to a coverage area of a BS and/or a BS subsystem serving this coverage area, depending on the context in which the term is used.

A BS may provide communication coverage for a macro cell, a pico cell, a femto cell, and/or another type of cell. A macro cell may cover a relatively large geographic area (e.g., several kilometers in radius) and may allow unrestricted access by UEs with service subscription. A pico cell may cover a relatively small geographic area and may allow unrestricted access by UEs with service subscription. A femto cell may cover a relatively small geographic area (e.g., a home) and may allow restricted access by UEs having association with the femto cell (e.g., UEs in a closed subscriber group (CSG)). ABS for a macro cell may be referred to as a macro BS. ABS for a pico cell may be referred to as a pico BS. A BS for a femto cell may be referred to as a femto BS or a home BS. In the example shown in FIG. 1, a BS 110a may be a macro BS for a macro cell 102a, a BS 110b may be a pico BS for a pico cell 102b, and a BS 110c may be a femto BS for a femto cell 102c. A BS may support one or multiple (e.g., three) cells. The terms “eNB”, “base station”, “NR BS”, “gNB”, “TRP”, “AP”, “node B”, “5G NB”, and “cell” may be used interchangeably herein.

In some aspects, a cell may not necessarily be stationary, and the geographic area of the cell may move according to the location of a mobile BS. In some aspects, the BSs may be interconnected to one another and/or to one or more other BSs or network nodes (not shown) in the wireless network 100 through various types of backhaul interfaces, such as a direct physical connection or a virtual network, using any suitable transport network.

Wireless network 100 may also include relay stations. A relay station is an entity that can receive a transmission of data from an upstream station (e.g., a BS or a UE) and send a transmission of the data to a downstream station (e.g., a UE or a BS). A relay station may also be a UE that can relay transmissions for other UEs. In the example shown in FIG. 1, a relay BS 110d may communicate with macro BS 110a and a UE 120d in order to facilitate communication between BS 110a and UE 120d. A relay BS may also be referred to as a relay station, a relay base station, a relay, a repeater, or the like.

Wireless network 100 may be a heterogeneous network that includes BSs of different types, such as macro BSs, pico BSs, femto BSs, relay BSs, or the like. These different types of BSs may have different transmit power levels, different coverage areas, and different impacts on interference in wireless network 100. For example, macro BSs may have a high transmit power level (e.g., 5 to 40 watts) whereas pico BSs, femto BSs, and relay BSs may have lower transmit power levels (e.g., 0.1 to 2 watts).

A network controller 130 may couple to a set of BSs and may provide coordination and control for these BSs. Network controller 130 may communicate with the BSs via a backhaul. The BSs may also communicate with one another, directly or indirectly, via a wireless or wireline backhaul.

UEs 120 (e.g., 120a, 120b, 120c) may be dispersed throughout wireless network 100, and each UE may be stationary or mobile. A UE may also be referred to as an access terminal, a terminal, a mobile station, a subscriber unit, a station, or the like. A UE may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device or equipment, biometric sensors/devices, wearable devices (smart watches, smart clothing, smart glasses, smart wrist bands, smart jewelry (e.g., smart ring, smart bracelet)), an entertainment device (e.g., a music or video device, or a satellite radio), a vehicular component or sensor, smart meters/sensors, industrial manufacturing equipment, a global positioning system device, or any other suitable device that is configured to communicate via a wireless or wired medium.

Some UEs may be considered machine-type communication (MTC) or evolved or enhanced machine-type communication (eMTC) UEs. MTC and eMTC UEs include, for example, robots, drones, remote devices, sensors, meters, monitors, and/or location tags, that may communicate with a base station, another device (e.g., remote device), or some other entity. A wireless node may provide, for example, connectivity for or to a network (e.g., a wide area network such as Internet or a cellular network) via a wired or wireless communication link. Some UEs may be considered Internet-of-Things (IoT) devices, and/or may be implemented as NB-IoT (narrowband internet of things) devices. Some UEs may be considered a Customer Premises Equipment (CPE). UE 120 may be included inside a housing that houses components of UE 120, such as processor components and/or memory components. In some aspects, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks may be deployed in a given geographic area. Each wireless network may support a particular RAT and may operate on one or more frequencies. A RAT may also be referred to as a radio technology, an air interface, or the like. A frequency may also be referred to as a carrier, a frequency channel, or the like. Each frequency may support a single RAT in a given geographic area in order to avoid interference between wireless networks of different RATs. In some cases, NR or 5G RAT networks may be deployed, and/or WiFi networks may be deployed.

In some aspects, two or more UEs 120 (e.g., shown as UE 120a and UE 120e) may communicate directly using one or more sidelink channels (e.g., without using a base station 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol or a vehicle-to-infrastructure (V2I) protocol), and/or a mesh network. In this case, the UE 120 may perform scheduling operations, resource selection operations, and/or other operations described elsewhere herein as being performed by the base station 110.

Devices of wireless network 100 may communicate using the electromagnetic spectrum, which may be subdivided based on frequency or wavelength into various classes, bands, channels, or the like. For example, devices of wireless network 100 may communicate using an operating band having a first frequency range (FR1), which may span from 410 MHz to 7.125 GHz, and/or may communicate using an operating band having a second frequency range (FR2), which may span from 24.25 GHz to 52.6 GHz. The frequencies between FR1 and FR2 are sometimes referred to as mid-band frequencies. Although a portion of FR1 is greater than 6 GHz, FR1 is often referred to as a “sub-6 GHz” band. Similarly, FR2 is often referred to as a “millimeter wave” band despite being different from the extremely high frequency (EHF) band (30 GHz-300 GHz) which is identified by the International Telecommunications Union (ITU) as a “millimeter wave” band. Thus, unless specifically stated otherwise, it should be understood that the term “sub-6 GHz” or the like, if used herein, may broadly represent frequencies less than 6 GHz, frequencies within FR1, and/or mid-band frequencies (e.g., greater than 7.125 GHz). Similarly, unless specifically stated otherwise, it should be understood that the term “millimeter wave” or the like, if used herein, may broadly represent frequencies within the EHF band and/or frequencies within FR2. It is contemplated that the frequencies included in FR1 and FR2 may be modified, and techniques described herein are applicable to those modified frequency ranges. Devices of wireless network 100 may communicate in bands which are higher than a “millimeter wave” band. For example, devices of wireless network 100 may communicate in sub-terahertz (sub-THz) bands, for example which include frequencies that are multiple hundreds of GHz.

As indicated above, FIG. 1 is provided as an example. Other examples may differ from what is described with regard to FIG. 1.

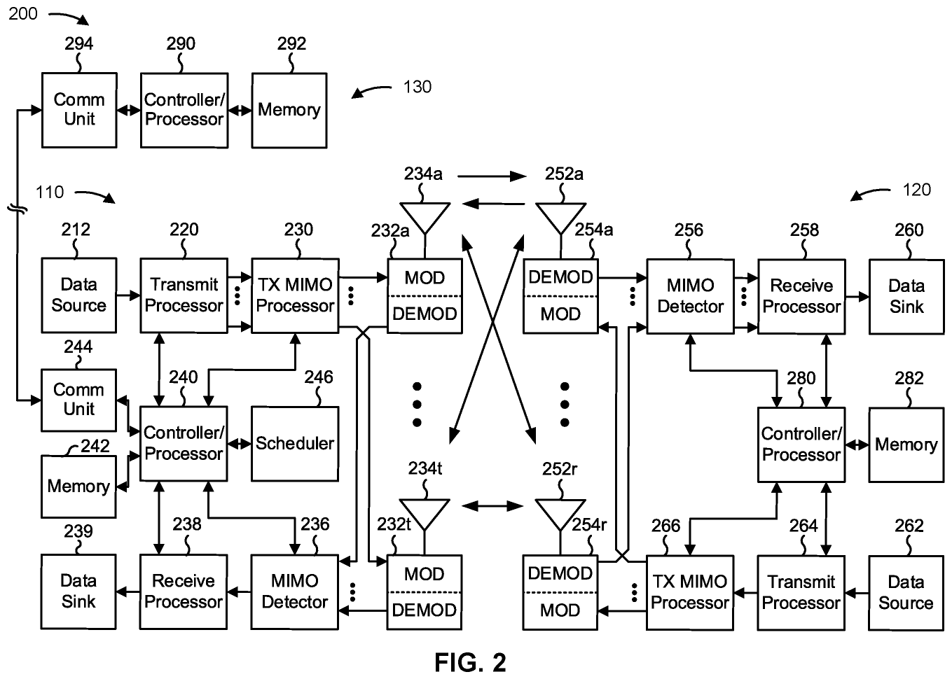

FIG. 2 is a diagram illustrating an example 200 of a base station 110 in communication with a UE 120 in a wireless network 100, in accordance with the present disclosure. Base station 110 may be equipped with T antennas 234a through 234t, and UE 120 may be equipped with R antennas 252a through 252r, where in general T≥1 and R≥1.

At base station 110, a transmit processor 220 may receive data from a data source 212 for one or more UEs, select one or more modulation and coding schemes (MCS) for each UE based at least in part on channel quality indicators (CQIs) received from the UE, process (e.g., encode and modulate) the data for each UE based at least in part on the MCS(s) selected for the UE, and provide data symbols for all UEs. Transmit processor 220 may also process system information (e.g., for semi-static resource partitioning information (SRPI)) and control information (e.g., CQI requests, grants, and/or upper layer signaling) and provide overhead symbols and control symbols. Transmit processor 220 may also generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide T output symbol streams to T modulators (MODs) 232a through 232t. Each modulator 232 may process a respective output symbol stream (e.g., for OFDM) to obtain an output sample stream. Each modulator 232 may further process (e.g., convert to analog, amplify, filter, and upconvert) the output sample stream to obtain a downlink signal. T downlink signals from modulators 232a through 232t may be transmitted via T antennas 234a through 234t, respectively. The base station 110 may also be configured to transmit a single stream via one or more of the antennas 234.

At UE 120, antennas 252a through 252r may receive the downlink signal(s) from base station 110 and/or other base stations and may provide received signals to demodulators (DEMODs) 254a through 254r, respectively. Each demodulator 254 may condition (e.g., filter, amplify, downconvert, and digitize) a received signal to obtain input samples. Each demodulator 254 may further process the input samples (e.g., for OFDM) to obtain received symbols. A MIMO detector 256 may obtain received symbols from all R demodulators 254a through 254r, perform MIMO detection on the received symbols if applicable, and provide detected symbols. A receive processor 258 may process (e.g., demodulate and decode) the detected symbols, provide decoded data for UE 120 to a data sink 260, and provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some aspects, one or more components of UE 120 may be included in a housing.

Network controller 130 may include communication unit 294, controller/processor 290, and memory 292. Network controller 130 may include, for example, one or more devices in a core network. Network controller 130 may communicate with base station 110 via communication unit 294.

Antennas (e.g., antennas 234a through 234t and/or antennas 252a through 252r) may include, or may be included within, one or more antenna panels, antenna groups, sets of antenna elements, and/or antenna arrays, among other examples. An antenna panel, an antenna group, a set of antenna elements, and/or an antenna array may include one or more antenna elements. An antenna panel, an antenna group, a set of antenna elements, and/or an antenna array may include a set of coplanar antenna elements and/or a set of non-coplanar antenna elements. An antenna panel, an antenna group, a set of antenna elements, and/or an antenna array may include antenna elements within a single housing and/or antenna elements within multiple housings. An antenna panel, an antenna group, a set of antenna elements, and/or an antenna array may include one or more antenna elements coupled to one or more transmission and/or reception components, such as one or more components of FIG. 2.

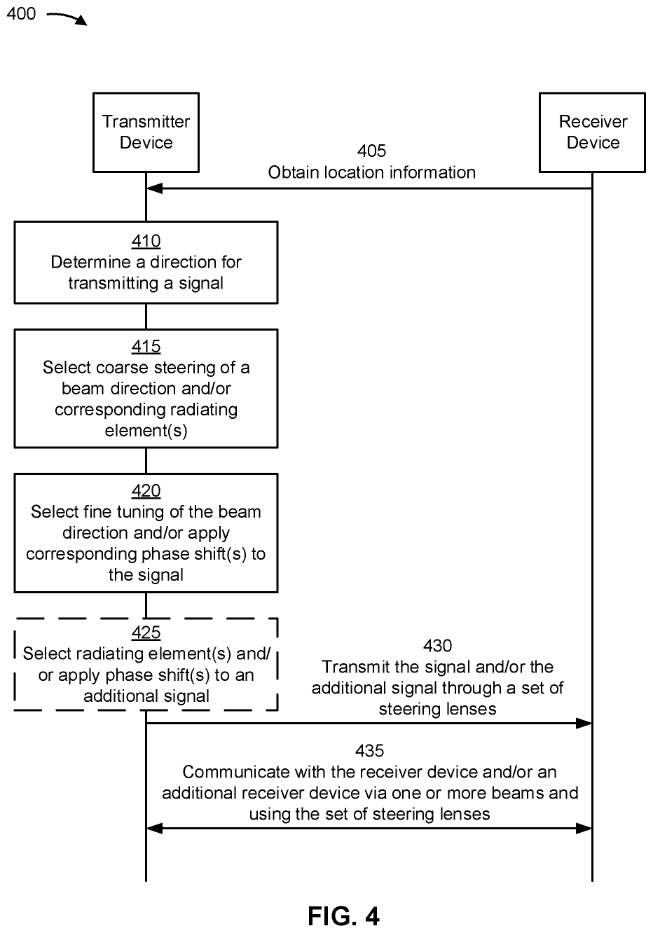

On the uplink, at UE 120, a transmit processor 264 may receive and process data from a data source 262 and control information (e.g., for reports that include RSRP, RSSI, RSRQ, and/or CQI) from controller/processor 280. Transmit processor 264 may also generate reference symbols for one or more reference signals. The symbols from transmit processor 264 may be precoded by a TX MIMO processor 266 if applicable, further processed by modulators 254a through 254r (e.g., for DFT-s-OFDM or CP-OFDM), and transmitted to base station 110. In some aspects, a modulator and a demodulator (e.g., MOD/DEMOD 254) of the UE 120 may be included in a modem of the UE 120. In some aspects, the UE 120 includes a transceiver. The transceiver may include any combination of antenna(s) 252, modulators and/or demodulators 254, MIMO detector 256, receive processor 258, transmit processor 264, and/or TX MIMO processor 266. The transceiver may be used by a processor (e.g., controller/processor 280) and memory 282 to perform aspects of any of the methods described herein (for example, as described with reference to FIGS. 4-11).

At base station 110, the uplink signal(s) from UE 120 and other UEs may be received by antennas 234, processed by demodulators 232, detected by a MIMO detector 236 if applicable, and further processed by a receive processor 238 to obtain decoded data and control information sent by UE 120. Receive processor 238 may provide the decoded data to a data sink 239 and the decoded control information to controller/processor 240. Base station 110 may include communication unit 244 and communicate to network controller 130 via communication unit 244. Base station 110 may include a scheduler 246 to schedule UEs 120 for downlink and/or uplink communications. In some aspects, a modulator and a demodulator (e.g., MOD/DEMOD 232) of the base station 110 may be included in a modem of the base station 110. In some aspects, the base station 110 includes a transceiver. The transceiver may include any combination of antenna(s) 234, modulators and/or demodulators 232, MIMO detector 236, receive processor 238, transmit processor 220, and/or TX MIMO processor 230. The transceiver may be used by a processor (e.g., controller/processor 240) and memory 242 to perform aspects of any of the methods described herein (for example, as described with reference to FIGS. 4-12).

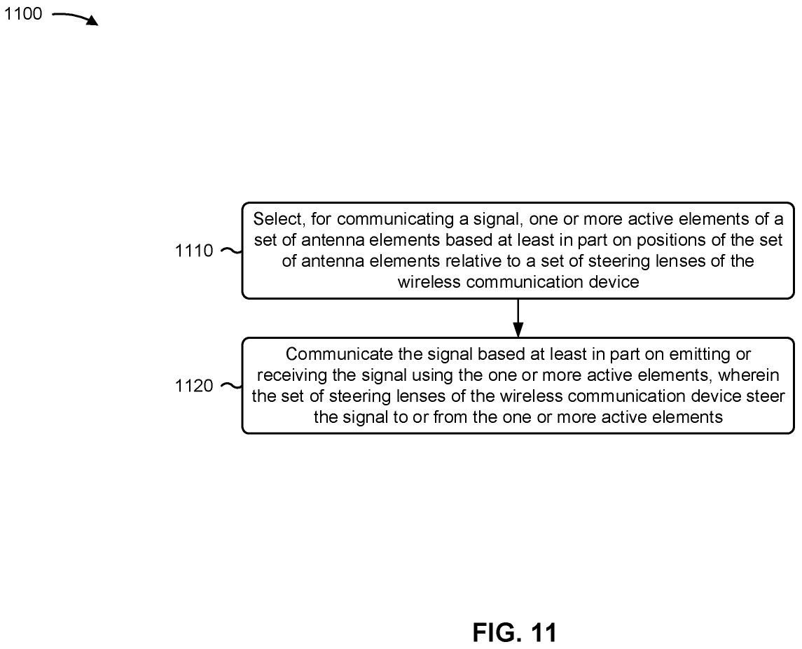

Controller/processor 240 of base station 110, controller/processor 280 of UE 120, and/or any other component(s) of FIG. 2 may perform one or more techniques associated with beam steering using a hybrid phased-array and steering lens, as described in more detail elsewhere herein. For example, controller/processor 240 of base station 110 may perform or direct operations of, for example, process 1100 of FIG. 11 and/or other processes as described herein. Memories 242 and 282 may store data and program codes for base station 110 and UE 120, respectively. In some aspects, memory 242 and/or memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the base station 110 and/or the UE 120, may cause the one or more processors, the UE 120, and/or the base station 110 to perform or direct operations of, for example, process 1100 of FIG. 11 and/or other processes as described herein. In some aspects, executing instructions may include running the instructions, converting the instructions, compiling the instructions, and/or interpreting the instructions, among other examples.

In some aspects, the wireless communication device (e.g., base station 110, a transmitter device, or a receiver device, among other examples) includes means for selecting, for communicating a signal, one or more active elements of a set of antenna elements based at least in part on positions of the one or more active elements of the set of antenna elements relative to a set of steering lenses of the wireless communication device; and/or means for communicating the signal based at least in part on emitting or receiving the signal using the one or more active elements, wherein the set of steering lenses of the wireless communication device steer the signal to or from the one or more active elements. In some aspects, the means for the wireless communication device to perform operations described herein may include, for example, one or more of transmit processor 220, TX MIMO processor 230, modulator 232, antenna 234, demodulator 232, MIMO detector 236, receive processor 238, controller/processor 240, memory 242, or scheduler 246. In some aspects, the means for the wireless communication device to perform operations described herein may include, for example, one or more of antenna 252, demodulator 254, MIMO detector 256, receive processor 258, transmit processor 264, TX MIMO processor 266, modulator 254, controller/processor 280, or memory 282.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of controller/processor 280.

As indicated above, FIG. 2 is provided as an example. Other examples may differ from what is described with regard to FIG. 2.

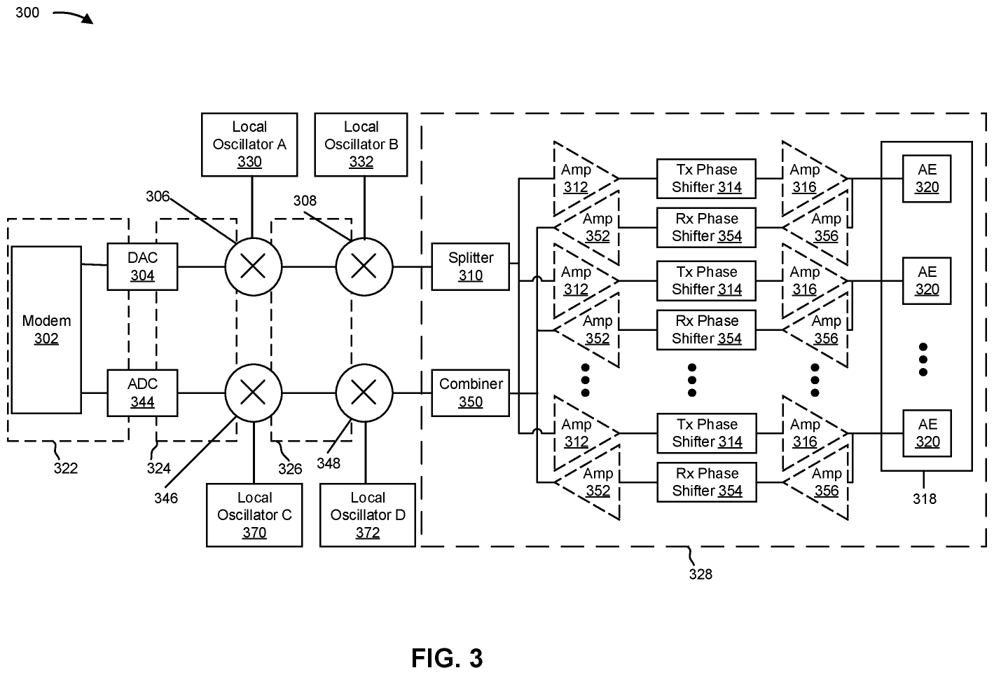

FIG. 3 is a diagram illustrating an example beamforming architecture 300 that supports beamforming for millimeter wave (mmW) communications or communications with a higher frequency, in accordance with various aspects of the present disclosure. In some aspects, architecture 300 may implement aspects of wireless network 100. In some aspects, architecture 300 may be implemented in a transmitter device (e.g., a first wireless communication device, UE, CPE, or base station) and/or a receiver device (e.g., a second wireless communication device, UE, CPE, or base station), as described herein.

Broadly, FIG. 3 is a diagram illustrating example hardware components of a wireless communication device in accordance with certain aspects of the disclosure. The illustrated components may include those that may be used for antenna element selection and/or for beamforming for transmission of wireless signals. There are numerous architectures for antenna element selection and implementing phase shifting, only one example of which is illustrated here. The architecture 300 includes a modem (modulator/demodulator) 302 (which may be an example of the data source 212, transmit processor 220, TX MIMO processor 230, controller/processor 240, scheduler 246, MIMO detector 236, receive processor 238, and/or data sink 239), a digital to analog converter (DAC) 304, a first mixer 306, a second mixer 308, and a splitter 310. The architecture 300 also includes multiple first amplifiers 312, multiple phase shifters 314, multiple second amplifiers 316, and an antenna array 318 that includes multiple antenna elements 320.

Transmission lines or other waveguides, wires, traces, and/or the like are shown connecting the various components to illustrate how signals to be transmitted may travel between components. Reference numbers 322, 324, 326, and 328 indicate regions in the architecture 300 in which different types of signals travel or are processed. Specifically, reference number 322 indicates a region in which digital baseband signals travel or are processed, reference number 324 indicates a region in which analog baseband signals travel or are processed, reference number 326 indicates a region in which analog intermediate frequency (IF) signals travel or are processed, and reference number 328 indicates a region in which analog radio frequency (RF) signals travel or are processed. The architecture also includes a local oscillator A 330 and a local oscillator B 332.

Each of the antenna elements 320 (also referred to herein as “radiating elements”) may include one or more sub-elements for radiating or receiving RF signals. For example, a single antenna element 320 may include a first sub-element cross-polarized with a second sub-element that can be used to independently transmit cross-polarized signals. The antenna elements 320 may include patch antennas, dipole antennas, or other types of antennas arranged in a linear pattern, a two dimensional pattern, or another pattern. A spacing between antenna elements 320 may be such that signals with a desired wavelength transmitted separately by the antenna elements 320 may interact or interfere (e.g., to form a desired beam). For example, given an expected range of wavelengths or frequencies, the spacing may provide a quarter wavelength, half wavelength, or other fraction of a wavelength of spacing between neighboring antenna elements 320 to allow for interaction or interference of signals transmitted by the separate antenna elements 320 within that expected range. In other examples, each of the antenna elements is aligned with and/or associated with a respective lens (as described below) and the spacing between antenna elements will therefore be approximately equal to a diameter of the lens plus any separation distance between lenses.

The modem 302 processes and generates digital baseband signals and may also control operation of the DAC 304, first and second mixers 306, 308, splitter 310, first amplifiers 312, phase shifters 314, and/or the second amplifiers 316 to transmit signals via one or more or all of the antenna elements 320. The modem 302 may process signals and control operation in accordance with a communication standard such as a wireless standard discussed herein. The DAC 304 may convert digital baseband signals received from the modem 302 (and that are to be transmitted) into analog baseband signals. The first mixer 306 upconverts analog baseband signals to analog IF signals within an IF using a local oscillator A 330. For example, the first mixer 306 may mix the signals with an oscillating signal generated by the local oscillator A 330 to “move” the baseband analog signals to the IF. In some cases, some processing or filtering (not shown) may take place at the IF. The second mixer 308 upconverts the analog IF signals to analog RF signals using the local oscillator B 332. Similar to the first mixer, the second mixer 308 may mix the signals with an oscillating signal generated by the local oscillator B 332 to “move” the IF analog signals to the RF or the frequency at which signals will be transmitted or received. The modem 302 may adjust the frequency of local oscillator A 330 and/or the local oscillator B 332 so that a desired IF and/or RF frequency is produced and used to facilitate processing and transmission of a signal within a desired bandwidth.

In the illustrated architecture 300, signals upconverted by the second mixer 308 are split or duplicated into multiple signals by the splitter 310. The splitter 310 in architecture 300 splits the RF signal into multiple identical or nearly identical RF signals. In other examples, the split may take place with any type of signal, including with baseband digital, baseband analog, or IF analog signals. Each of these signals may correspond to an antenna element 320, and the signal travels through and is processed by amplifiers 312, 316, phase shifters 314, and/or other elements corresponding to the respective antenna element 320 to be provided to and transmitted by the corresponding antenna element 320 of the antenna array 318. In one example, the splitter 310 may be an active splitter that is connected to a power supply and provides some gain so that RF signals exiting the splitter 310 are at a power level equal to or greater than the signal entering the splitter 310. In another example, the splitter 310 is a passive splitter that is not connected to power supply and the RF signals exiting the splitter 310 may be at a power level lower than the RF signal entering the splitter 310.

After being split by the splitter 310, the resulting RF signals may enter an amplifier, such as a first amplifier 312, or a phase shifter 314 corresponding to an antenna element 320. The first and second amplifiers 312, 316 are illustrated with dashed lines because one or both of them might not be necessary in some aspects. In some aspects, both the first amplifier 312 and second amplifier 316 are present. In some aspects, neither the first amplifier 312 nor the second amplifier 316 is present. In some aspects, one of the two amplifiers 312, 316 is present but not the other. By way of example, if the splitter 310 is an active splitter, the first amplifier 312 may not be used. By way of further example, if the phase shifter 314 is an active phase shifter that can provide a gain, the second amplifier 316 might not be used.

The amplifiers 312, 316 may provide a desired level of positive or negative gain. A positive gain (positive dB) may be used to increase an amplitude of a signal for radiation by a specific antenna element 320. A negative gain (negative dB) may be used to decrease an amplitude and/or suppress radiation of the signal by a specific antenna element. Each of the amplifiers 312, 316 may be controlled independently (e.g., by the modem 302) to provide independent control of the gain for each antenna element 320. For example, the modem 302 may have at least one control line connected to each of the splitter 310, first amplifiers 312, phase shifters 314, and/or second amplifiers 316 that may be used to configure a gain to provide a desired amount of gain for each component and thus each antenna element 320.

The phase shifter 314 may provide a configurable phase shift or phase offset to a corresponding RF signal to be transmitted. The phase shifter 314 may be a passive phase shifter not directly connected to a power supply. Passive phase shifters might introduce some insertion loss. The second amplifier 316 may boost the signal to compensate for the insertion loss. The phase shifter 314 may be an active phase shifter connected to a power supply such that the active phase shifter provides some amount of gain or prevents insertion loss. The settings of each of the phase shifters 314 are independent, meaning that each can be independently set to provide a desired amount of phase shift or the same amount of phase shift or some other configuration. The modem 302 may have at least one control line connected to each of the phase shifters 314 and which may be used to configure the phase shifters 314 to provide a desired amount of phase shift or phase offset between antenna elements 320.

In the illustrated architecture 300, RF signals received by the antenna elements 320 are provided to one or more first amplifiers 356 to boost the signal strength. The first amplifiers 356 may be connected to the same antenna array 318 (e.g., for time division duplex (TDD) operations). The first amplifiers 356 may be connected to different antenna arrays. The boosted RF signal is input into one or more phase shifters 354 to provide a configurable phase shift or phase offset for the corresponding received RF signal to enable reception via one or more Rx beams. The phase shifter 354 may be an active phase shifter or a passive phase shifter. The settings of the phase shifters 354 are independent, meaning that each can be independently set to provide a desired amount of phase shift or the same amount of phase shift or some other configuration. The modem 302 may have at least one control line connected to each of the phase shifters 354 and which may be used to configure the phase shifters 354 to provide a desired amount of phase shift or phase offset between antenna elements 320 to enable reception via one or more Rx beams.

The outputs of the phase shifters 354 may be input to one or more second amplifiers 352 for signal amplification of the phase shifted received RF signals. The second amplifiers 352 may be individually configured to provide a configured amount of gain. The second amplifiers 352 may be individually configured to provide an amount of gain to ensure that the signals input to combiner 350 have the same magnitude. The amplifiers 352 and/or 356 are illustrated in dashed lines because they might not be necessary in some aspects. In some aspects, both the amplifier 352 and the amplifier 356 are present. In another aspect, neither the amplifier 352 nor the amplifier 356 are present. In other aspects, one of the amplifiers 352, 356 is present but not the other.

In the illustrated architecture 300, signals output by the phase shifters 354 (via the amplifiers 352 when present) are combined in combiner 350. The combiner 350 in architecture 300 combines the RF signals into a signal. The combiner 350 may be a passive combiner (e.g., not connected to a power source), which may result in some insertion loss. The combiner 350 may be an active combiner (e.g., connected to a power source), which may result in some signal gain. When combiner 350 is an active combiner, it may provide a different (e.g., configurable) amount of gain for each input signal so that the input signals have the same magnitude when they are combined. When combiner 350 is an active combiner, the combiner 350 may not need the second amplifier 352 because the active combiner may provide the signal amplification.

The output of the combiner 350 is input into mixers 348 and 346. Mixers 348 and 346 generally down convert the received RF signal using inputs from local oscillators 372 and 370, respectively, to create intermediate or baseband signals that carry the encoded and modulated information. The output of the mixers 348 and 346 are input into an analog-to-digital converter (ADC) 344 for conversion to digital signals. The digital signals output from ADC 344 are input to modem 302 for baseband processing, such as decoding, de-interleaving, and/or the like.

While each antenna element 320 is illustrated as being coupled to a separate transmit (e.g., having components 312, 314, 316) and receive (e.g., having components 352, 354, 356) portions, one or more elements of the transmit or receive portions may be combined and/or shared between transmit and receive functions. For example, a bidirectional phase shifter may be used in place of the phase shifters 314, 354 and shared by transmit and receive functions, and/or a bidirectional amplifier may be used in place of the amplifiers 312, 352 and shared by transmit and receive functions.

The architecture 300 is given by way of example only to illustrate an architecture for transmitting and/or receiving signals. In some cases, the architecture 300 and/or each portion of the architecture 300 may be repeated multiple times within an architecture to accommodate or provide an arbitrary number of RF chains, antenna elements, and/or antenna panels. For example, multiple analog signal regions (324, 326, 328) may be coupled to a single modem 302. Furthermore, numerous alternate architectures are possible and contemplated. For example, although only a single antenna array 318 is shown, two, three, or more antenna arrays may be included, each with one or more of their own corresponding amplifiers, phase shifters, splitters, mixers, DACs, ADCs, and/or modems. For example, a single UE may include two, three, four, or more antenna arrays for transmitting or receiving signals at different physical locations on the UE or in different directions.

Furthermore, mixers, splitters, amplifiers, phase shifters and other components may be located in different signal type areas (e.g., represented by different ones of the reference numbers 322, 324, 326, 328) in different implemented architectures. For example, a split of the signal to be transmitted into multiple signals may take place at the analog RF, analog IF, analog baseband, or digital baseband frequencies in different examples. Similarly, amplification and/or phase shifts may also take place at different frequencies. For example, in some aspects, one or more of the splitters 310, amplifiers 312, 316, or phase shifters 314 may be located between the DAC 304 and the first mixer 306 or between the first mixer 306 and the second mixer 308. In one example, the functions of one or more of the components may be combined into one component. For example, the phase shifters 314 may perform amplification to include or replace the first and/or or second amplifiers 312, 316. By way of another example, a phase shift may be implemented by the second mixer 308 to obviate the need for a separate phase shifter 314. This technique is sometimes called local oscillator (LO) phase shifting. In some aspects of this configuration, there may be multiple IF to RF mixers (e.g., for each antenna element chain) within the second mixer 308, and the local oscillator B 332 may supply different local oscillator signals (with different phase offsets) to each IF to RF mixer. In other embodiments, phases of the signals or other offsets or are introduced digitally (e.g., by the modem 302).

The modem 302 may control one or more of the other components 304 through 372 to select one or more antenna elements 320 and/or to form beams for transmission of one or more signals. For example, the antenna elements 320 may be individually selected or deselected for transmission of a signal (or signals) by controlling an amplitude of one or more corresponding amplifiers, such as the first amplifiers 312 and/or the second amplifiers 316. Beamforming includes generation of a beam using multiple signals on different antenna elements, where one or more or all of the multiple signals are shifted in phase relative to each other. The formed beam may carry physical or higher layer reference signals or information. As each signal of the multiple signals is radiated from a respective antenna element 320, the radiated signals interact/interfere (constructive and destructive interference) with each other to form a resulting beam. The shape (such as the amplitude, width, and/or presence of side lobes) and the direction (such as an angle of the beam relative to a surface of the antenna array 318) can be dynamically controlled by modifying the phase shifts or phase offsets imparted by the phase shifters 314 and amplitudes imparted by the amplifiers 312, 316 of the multiple signals relative to each other.

As indicated above, FIG. 3 is provided as an example. Other examples may differ from what is described with regard to FIG. 3.

Beam forming using phased arrays, as described relative to the transmitter device of FIG. 3, can be helpful to focus signals emitted from the transmitter device so that the signals can reach a receiver device. For example, focusing the beam may provide an increased power density for a transmission, which may extend a range of the transmission. However, to steer beams, the transmitter device may require a significant number of radiating elements to provide flexibility to modify an angle of a steered beam. For example, array directivity (e.g., an amount by which an angle can be modified) may be proportional to a number of radiating elements. In some aspects, a beam divergence (e.g., amount by which an angle can be modified) may be proportional to a quotient of a wavelength of a transmitted signal and a diameter of an aperture of the radiating elements. In an example, for a signal having a frequency of 100 gigahertz (GHz), a beam divergence of 6 degrees may require an aperture of about 3 centimeters. With an inter-element separation of ½ of a wavelength of the signal and an aperture of approximately 10 times the wavelength, the transmitter device may have 400 radiating elements in an array (e.g., 20 elements by 20 elements). Using 400 radiating elements may consume an unnecessarily high amount of power resources of the transmitter device, may require associated circuitry to control emissions using the 400 radiating elements, may consume space within the transmitter device, and/or the like.

In some aspects described herein, a wireless communication device (e.g., base station 110, UE 120, CPE, a transmitter device, or a receiver device, among other examples) may use a hybrid system of an array of steering lenses and a phased array of radiating elements. Such system may provide high directivity capabilities to the transmitter device or receiver device. In some aspects, the wireless communication device may use the array of steering lenses to provide coarse steering for a beam. The wireless communication device may use a phased array of radiating elements to feed the steering lens array to enable fine-tuning to a direction of the beam. In some aspects, the wireless communication device may use one or more Butler matrixes to provide phase shifting to the signal, to spatially multiplex multiple signals, and/or the like.

By using a hybrid system of an array of steering lenses and a phased array of radiating elements, the wireless communication device may be configured for high directivity with a relatively low number of radiating elements when compared to a system without the array of steering lenses. For example, a single radiating element with a single steering lens may have a same beam divergence as the example wireless communication device having 400 radiating elements. Based at least in part on using the hybrid system, the wireless communication device may conserve power resources, may require fewer radiating elements and/or less associated circuitry, may conserve space within the wireless communication device, and/or the like. Further, a high beam gain may be realized, a continuously steerable beam (e.g., with fine or relatively narrow beams) may be enabled across a relatively wide field of view, and/or simultaneous transmission of multiple streams of data may be accomplished.

FIG. 4 is a diagram illustrating an example 400 associated with beam steering using a hybrid phased-array and steering lens, in accordance with various aspects of the present disclosure. As shown in FIG. 4, a transmitter device (e.g., base station 110, UE 120, or a wireless communication device, among other examples) may communicate with a receiver device (e.g., base station 110, UE 120, CPE, or a wireless communication device, among other examples). The transmitter device and the receiver device may be part of a wireless network (e.g., wireless network 100).

In some aspects, the transmitter device and/or the receiver device may be configured with a hybrid system of an array of steering lenses and a phased array of antenna elements. A number of lenses of the array of steering lenses may be based at least in part on one or more frequencies (e.g., center frequencies) on which the transmitter device and/or the receiver device are configured to communicate. For example, the transmitter device may be configured to communicate at a center frequency of approximately 150 GHz, may include an array of steering lenses having diameters (e.g., in a direction that is parallel to the phased array of antenna elements) in a range of approximately 10 wavelengths to approximately 100 wavelengths (e.g., approximately 2 centimeters or in a range from approximately 10 centimeters to approximately 100 centimeters, among other examples, such as diameters that are 1 centimeter or less), and/or may have a focal length that is approximately equal to the diameters, among other examples. In some aspects, the diameters may be based at least in part on tolerance of aberrations in the lens. In some embodiments, a lens diameter of approximately 3 centimeters is used for communications having a frequency of approximately 100 GHz. In some embodiments, a lens diameter of approximately 10 centimeters is used for communications having a frequency of approximately 30 GHz. In some embodiments, a wavelength of the communications is much less than the diameter and/or the focal length of the lens.

In some aspects, the transmitter device and/or the receiver device may select one or more active elements of the phased array of antenna elements to provide course steering of a beam (e.g., to select a range of angles (e.g., in 6 degree increments) associated with the selected one or more active elements). The transmitter device and/or the receiver device may apply a set of phase shifts to signals transmitted or received via the one or more active elements to fine tune the signals.

As shown in FIG. 4, and by reference number 405, the transmitter device may obtain location information. In some aspects, the transmitter device may obtain the location information explicitly from the receiver device (e.g., via control signaling), via a beam sweeping process, via a channel state feedback report, via a channel state information report, and/or the like. The location information may include a geolocation of the transmitter device, a geolocation of the receiver device, a location of the receiver device relative to the transmitter device, one or more beam directions for communications between the transmitter device and the receiver device, and/or the like.

As shown by reference number 410, the transmitter device may determine a direction for transmitting a signal to the receiver device. In some aspects, the transmitter device may determine the direction for transmitting the signal to the receiver based at least in part on the location information.

As shown by reference number 415, the transmitter device may select coarse steering of a beam direction and/or select one or more corresponding antenna elements for transmitting the signal. For example, the transmitter device may select one or more active elements of a set of antenna elements based at least in part on positions of the set of antenna elements relative to a set of steering lenses of the transmitter device. In some aspects, selecting the one or more active elements of the set of antenna elements may be based at least in part on the coarse steering.

In some aspects, antenna elements of the set of antenna elements are positioned along a focal plane of at least one of the set of steering lenses. The transmitter device may select the one or more active elements based at least in part on an offset distance (and/or offset direction) from an optical axis of a steering lens of the set of steering lenses. The offset distance (and/or direction) may correspond to an angle of a steered beam that is emitted from the one or more active elements through the set of steering lenses. The angle of the steered beam may correspond (e.g., coarsely correspond) to the direction for transmitting the signal.

As shown by reference number 420, the transmitter device may select fine tuning of the beam and/or apply one or more corresponding phase shifts to the signal. In some aspects, the transmitter device may apply one or more phase shifts to the signal based at least in part on fine tuning the beam direction (e.g., within a range or direction determined by the coarse steering). In some aspects, the transmitter device may apply different phase shifts to the signal before providing phase shifted instances of the signal to different antenna elements of the one or more active elements. In some aspects, the transmitter device may apply the one or more phase shifts to the signal using one or more analog phase shifters, digital phase shifters, Butler matrixes, and/or the like.

As shown by reference number 425, the transmitter device may optionally select one or more additional active elements and/or apply one or more additional phase shifts to an additional signal. In some aspects, the transmitter device may select the one or more additional antenna elements and/or apply the one or more additional phase shifts to the additional signal based at least in part on determining a direction for transmitting the additional signal (e.g., as described herein with reference to the signal).

The transmitter device may multiplex the signal and the additional signal using lens selection (e.g., a different lens for each signal) and/or using phase shifting (e.g., using different phase shifts and/or a same set of one or more lenses). In some aspects, the transmitter device may transmit the signal and the additional signal to different devices. In some aspects, the transmitter device may transmit the signal to a first receiver device and transmit the additional signal to a second receiver device. In other aspects, the signal and the additional signal may be transmitted to respective antennas (or antenna arrays) of a single receiver device.

In some aspects, the transmitter device may spatially multiplex the signal and the additional signal based at least in part on transmitting the signal using a set of antenna elements that is different from a set of antenna elements used to transmit the additional signal. In other words, the one or more additional antenna elements may include at least one antenna element that is not included in the one or more active elements, and/or the one or more active elements may include at least one antenna element that is not included in the one or more additional antenna elements. In some aspects, the one or more active elements and the one or more additional antenna elements may be mutually exclusive (e.g., no antenna elements are within both of the one or more active elements and the one or more additional antenna elements).

In some aspects, the transmitter device may apply a first set of phase shifts to the signal before emitting the signal from the one or more active elements, and may apply a second set of phase shifts to the additional signal before emitting the additional signal from the one or more active elements. In some aspects, the first set of phase shifts may be different from the second set of phase shifts. The transmitter device may apply the first set of phase shifts and/or the second set of phase shifts using one or more analog phase shifters, one or more digital phase shifters, one or more Butler matrixes, and/or the like.

As shown by reference number 430, the transmitter device may transmit the signal and/or the additional signal through a set of steering lenses. In some aspects, the transmitter device may emit the signal and/or the additional signal via antenna elements and through the set of steering lenses to provide beam steering. In some aspects, the set of steering lenses are fixed relative to the set of antenna elements. In some aspects, antenna elements of the set of antenna elements may be positioned on a focal plane of an associated steering lens of the set of steering lenses. In some aspects, the set of steering lenses may include one or more convex lenses, one or more spherical lenses, one or more aspherical lenses, one or more single element lenses, one or more multiple element lenses, one or more composite lenses, and/or one or more graded (or gradient) index lenses.

As shown by reference number 435, the transmitter device may communicate with the receiver device and/or an additional receiver device via one or more beams and using the set of steering lenses. In some aspects, the transmitter device may receive one or more signals from the receiver device and/or the additional receiver device by receiving the one or more signals via the set of steering lenses.

Based at least in part on the transmitter device using a hybrid system of an array of steering lenses (e.g., a set of steering lenses) and a phased array of antenna elements, the transmitter device may be configured for high directivity with a relatively low number of antenna elements when compared to a system without the array of steering lenses. In this way, the transmitter device may conserve power resources, may require fewer antenna elements and/or less associated circuitry, may conserve space within the transmitter device, and/or the like. Further, a high beam gain may be realized, a continuously steerable beam (e.g., with fine or relatively narrow beams) may be enabled across a relatively wide field of view, and/or simultaneous transmission of multiple streams of data may be accomplished.

As indicated above, FIG. 4 is provided as an example. Other examples may differ from what is described with regard to FIG. 4.

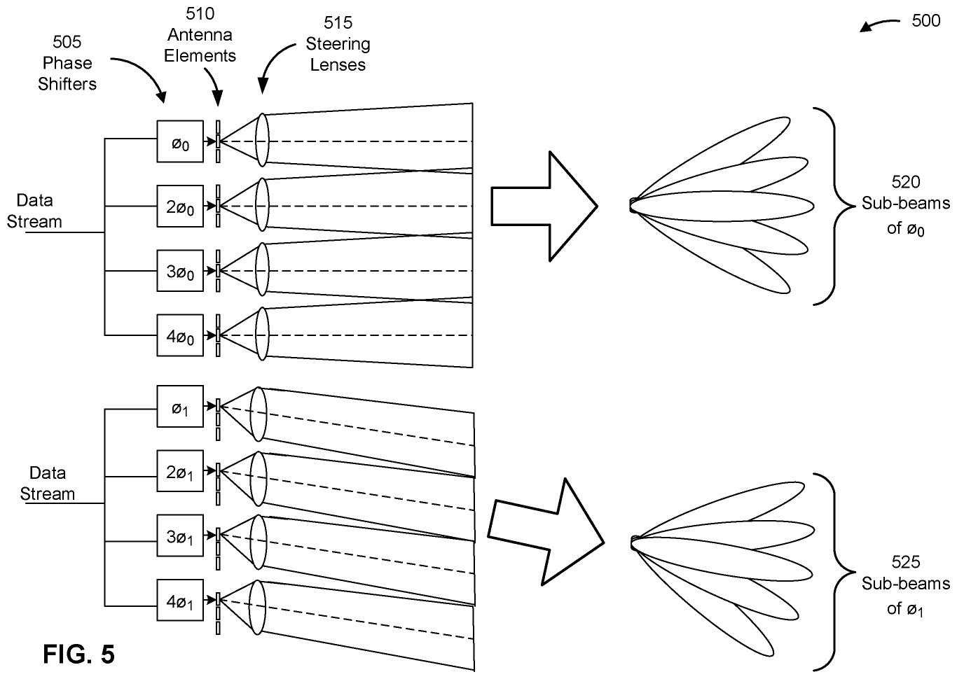

FIGS. 5-10 are diagrams illustrating examples associated with a hybrid phased-array and steering lenses for beam steering, in accordance with various aspects of the present disclosure. The illustrated hybrid phased-array and steering lenses examples may be components of the transmitter device, base station 110, UE 120, and/or the like.

As shown in FIG. 5, example 500 includes a set of phase shifters 505 to apply phase shifts to a data stream before providing instances of the data stream to one or more antenna elements 510. The antenna elements 510 may emit (or receive) instances of the data stream through associated steering lenses of a set of steering lenses 515. As can be seen in FIG. 5, an array of antenna elements 510 may be associated/aligned with each lens of the set of steering lenses 515.

The transmitter device may perform coarse steering by choosing an antenna element based at least in part on an offset distance (and/or direction) from an optical axis of an associated steering lens. The transmitter device may perform fine tuning of a beam direction by performing one or more phase shifts to the data stream before providing instances of the data stream to the one or more antenna elements 510.

In a far field (e.g., at a location of a receiver device), one or more beams emitted from the antenna elements 510 may combine coherently to form a combined beam. The combined beam may be a single, highly directional beam when compared to a phase array transmitter device without steering lenses.

As shown by reference numbers 520 and 525, the combined beam may include one or more sub-beams that may be chosen based at least in part on phase shifts applied to instances of the data stream. In this way, the transmitter device may choose a sub-beam that improves a likelihood of a receiver device receiving the data stream.

While phase shifters 505 are shown in FIG. 5 as being coupled to only one antenna element for each lens for ease of illustration, it will be appreciated that a respective phase shifter 505 may be coupled to each antenna element 510. The phase shifters 505 may be examples of the phase shifters 314 and/or 354 (FIG. 3). Further, each of the antenna elements 510 may be an example of one of the antenna elements 320 (FIG. 3). A respective antenna element associated with each lens in the set of steering lenses 515 may collectively comprise an antenna array 318 as described with respect to FIG. 3. For example, the top-most antenna element associated with each lens in FIG. 5 may comprise a first antenna array 318 and may be configured to operate as a first phased array (pursuant to phase adjustments introduced by the phase shifters 312 and/or 352, an LO phase shift, a digital phase shift or phase shift introduced by the modem 302, etc.). Similarly, the middle antenna elements associated with each lens in FIG. 5 may comprise a second antenna array 318 and may be configured to operate as a second phased array, which may be operated independently of the first phased array; and the bottom-most antenna elements associated with each lens in FIG. 5 may comprise a third antenna array 318 and may be configured to operate as a third phased array, which may be operated independently of the first and/or second phased arrays.

While FIG. 5 illustrates 4 lenses and three antenna elements associated with each lens, those of skill in the art will appreciate that a greater or fewer number of lenses and/or antenna elements associated with each lens may be implemented. For example, four or more antenna elements may be associated with each lens, and 20 or more lenses may be implemented.

All of the phase shifters 505, antenna elements 510, and lenses 515 may be included in a single device. For example, all of these components may be contained within or attached to a housing and/or attached to an interconnected or common frame.

The upper portion and the lower portion of FIG. 5 (illustrating configurations which produce sub-beams 520, 525) may be indicative of two separate subsystems of a single device, or may be indicative of the same system in two different configurations. For example, the upper portion may be indicative of a first set of phase shifts being applied to the middle antenna elements of a set of antenna elements to transmit a first data stream, and the lower portion may be indicative of a second set of phase shifts (which may be similar or different to the first set of phase shifts) to the top-most antenna elements of the same set of antenna elements to transmit a second data stream. As can be seen in FIG. 5, a coarse beam direction (e.g., roughly perpendicular to the array of antennas in the top portion, or angled down in the bottom portion) may be determined by selecting which antenna elements to activate, and a fine beam direction within that coarse beam direction may be determined by applying appropriate phase offsets to the active antennas.

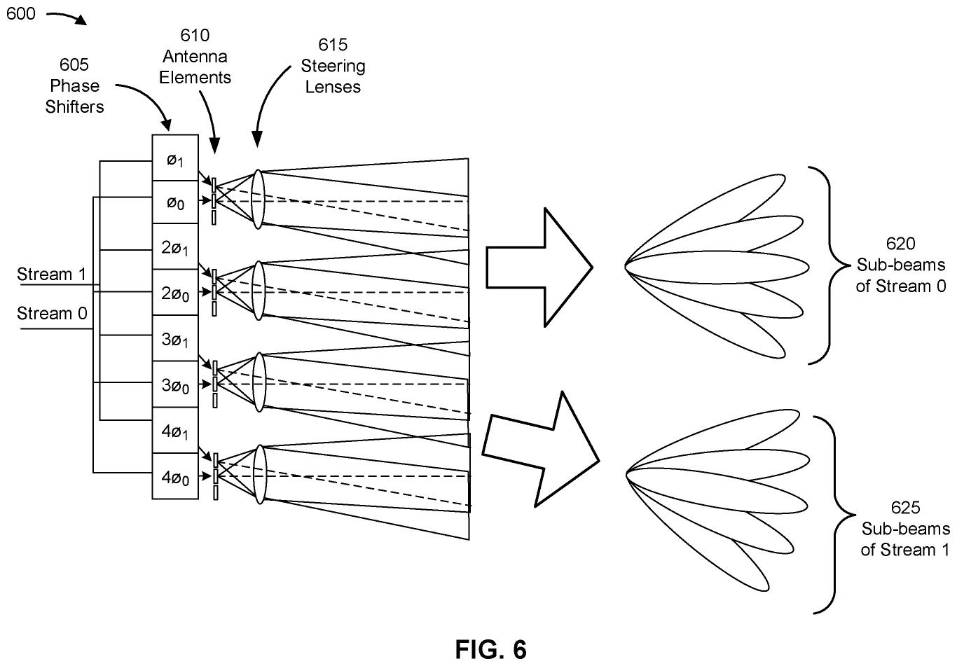

As shown in FIG. 6, example 600 includes a set of phase shifters 605 to apply phase shifts to data streams before providing instances of data stream 0 and data stream 1 to one or more antenna elements 610. The antenna elements 610 may emit (or receive) instances of data stream 0 and data stream 1 through associated steering lenses of a set of steering lenses 615. In some aspects, a first set of the antenna elements 610 used to emit instances of data steam 0 includes at least one element that is not within a second set of the antenna elements 610 used to emit instances of data stream 1. In some aspects, the first set of the antenna elements 610 is mutually exclusive with the second set of the antenna elements 610. In this way, the transmitter device may spatially multiplex stream 0 and stream 1. The phase shifters 605 may be examples of the phase shifters 314 and/or 354 (FIG. 3), and each of the antenna elements 610 may be an example of one of the antenna elements 320 (FIG. 3). A greater or fewer number of antenna elements 610 and/or lenses 615 may be implemented.

In a far field, one or more beams emitted from the antenna elements 610 may combine coherently to form a first combined beam and a second combined beam. The first combined beam and the second combined beam may be single, highly directional beams when compared to a phase array transmitter device without steering lenses.

As shown by reference number 620, the first combined beam may include one or more sub-beams that may be chosen based at least in part on phase shifts applied to instances of data stream 0. In this way, the transmitter device may choose a sub-beam that improves a likelihood of a first receiver device receiving data stream 0.

As shown by reference number 625, the second combined beam may include one or more sub-beams that may be chosen based at least in part on phase shifts applied to instances of data stream 1. In this way, the transmitter device may choose a sub-beam that improves a likelihood of a second receiver device receiving the data stream 1.

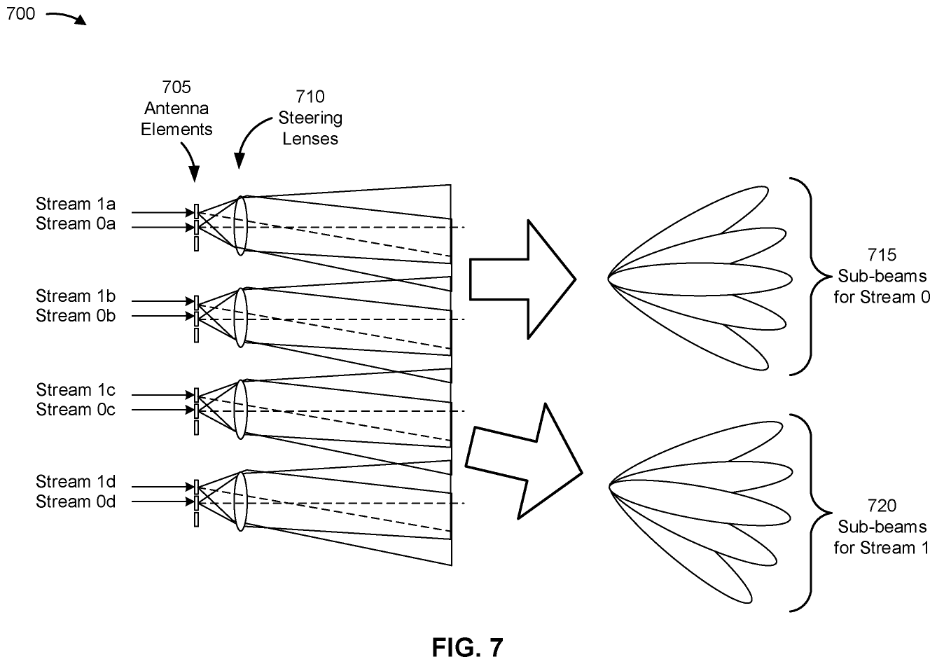

As shown in FIG. 7, example 700 includes antenna elements 705 that may emit (or receive) instances of data stream 0 and data stream 1 that have had phases applied by a digital phase shifter. For example, antenna elements having a first offset distance (and/or direction) from optical axes of associated steering lenses 710 may transmit streams 0a, 0b, 0c, and 0d through associated steering lenses of a set of steering lenses. Similarly, antenna elements having a second offset distance (and/or direction) from optical axes of associated steering lenses 710 may transmit streams 1a, 1b, 1c, and 1d through associated steering lenses of the set of steering lenses. Each of the antenna elements 705 may be an example of one of the antenna elements 320 (FIG. 3). The modem 302 (FIG. 3) and/or another component may apply or implement the digital phase shifts. A greater or fewer number of antenna elements 705 and/or lenses 710 may be implemented.

In a far field, one or more beams emitted from the antenna elements 705 may combine coherently to form a first combined beam and a second combined beam. The first combined beam and the second combined beam may be single, highly directional beams when compared to a phase array transmitter device without steering lenses.

As shown by reference number 715, the first combined beam may include one or more sub-beams, of which one or more (e.g., two, three, four, five, six, seven, or eight) may be used to communicate with a first receiver device (e.g., as a multi-layered communication link). In this way, the transmitter device may communicate with the first receiver device using multiple streams, which may increase a throughput of a communication link with the receiver device.

As shown by reference number 720, the second combined beam may include one or more sub-beams, of which one or more may be used to communicate with a second receiver device. In this way, the transmitter device may communicate with the second receiver device using multiple streams, which may increase a throughput of a communication link with the receiver device.

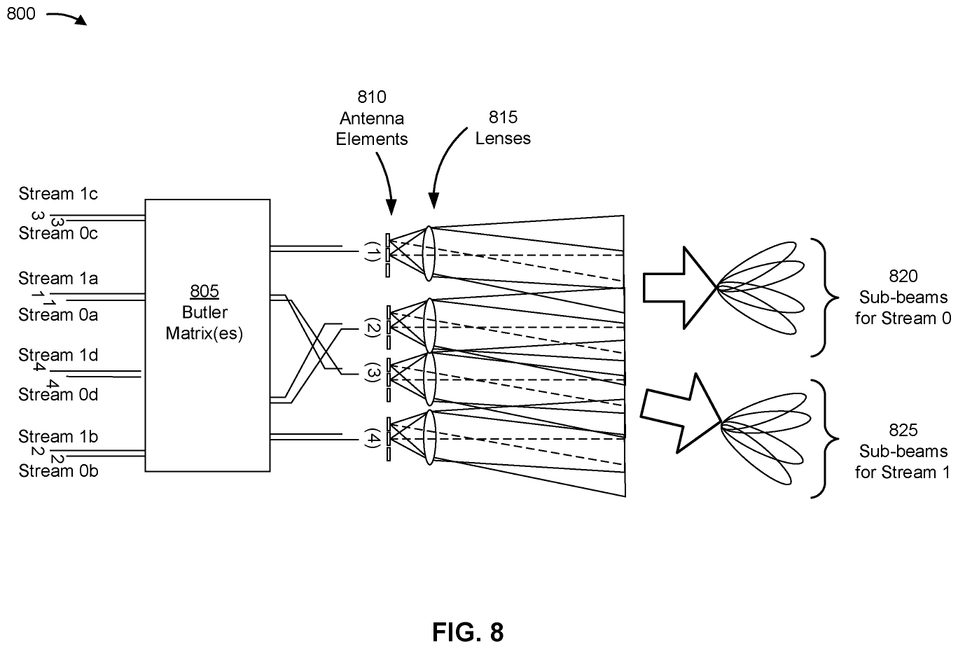

As shown in FIG. 8, example 800 includes one or more Butler matrixes 805 to apply phase shifts to data streams before providing instances of data stream 0 and data stream 1 to one or more antenna elements 810. The antenna elements 810 may emit instances of data stream 0 and data stream 1 through associated steering lenses of a set of steering lenses 815. In some aspects, antenna elements having a first offset distance (and/or direction) from optical axes of associated steering lenses may transmit streams 0a, 0b, 0c, and 0d through associated steering lenses of a set of steering lenses. For example, all of the top-most antenna elements 810 associated with each of the steering lenses 815 may transmit a respective portion of stream 0. Similarly, antenna elements having a second offset distance (and/or direction) from optical axes of associated steering lenses may transmit streams 1a, 1b, 1c, and 1d through associated steering lenses of the set of steering lenses. For example, all of the middle antenna elements 810 associated with each of the steering lenses 815 may transmit a respective portion of stream 1. Each of the antenna elements 810 may be an example of one of the antenna elements 320 (FIG. 3). A greater or fewer number of antenna elements 810 and/or lenses 815 may be implemented.

In a far field, one or more beams emitted from the antenna elements 810 may combine coherently to form a first combined beam and a second combined beam. The first combined beam and the second combined beam may be single, highly directional beams when compared to a phase array transmitter device without steering lenses.

As shown by reference number 820, the first combined beam may include one or more sub-beams, of which one or more (e.g., two, three, four, five, six, seven, or eight) may be used to communicate with a first receiver device (e.g., as a multi-layered communication link). In this way, the transmitter device may communicate with the first receiver device using multiple streams, which may increase a throughput of a communication link with the receiver device.

As shown by reference number 825, the second combined beam may include one or more sub-beams, of which one or more may be used to communicate with a second receiver device. In this way, the transmitter device may communicate with the second receiver device using multiple streams, which may increase a throughput of a communication link with the receiver device.

Based at least in part on using one or more Butler matrixes 805 to apply phase shifts to the instances of data stream 0 and data stream 1, the transmitter device may conserve power resources that may otherwise have been consumed to use digital phase shifters, may increase a throughput of the communication link when compared to using analog phase shifters, and/or may conserve communication resources by providing a highly directional beam, which may allow the transmitter device or other devices to use a same set of time-frequency resources outside of the highly directional beam.

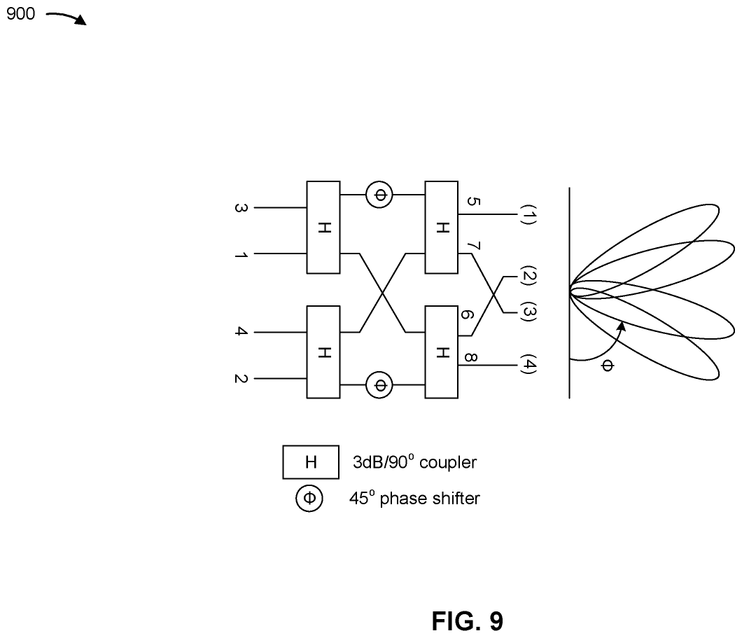

As shown in FIG. 9, example 900 includes a 4×4 Butler matrix having 4 transmission paths to antenna elements. As shown, the Butler matrix includes four 3 dB/90 degree couplers and two 45 degree phase shifters. Other examples of Butler matrixes include a 2×2 Butler matrix having 2 transmission paths, an 8×8 Butler matrix having 8 transmission paths, and/or the like. The Butler matrix may apply phase shifts to instances of a signal such that the instances of the signal are orthogonal and spaced through a range of angles.

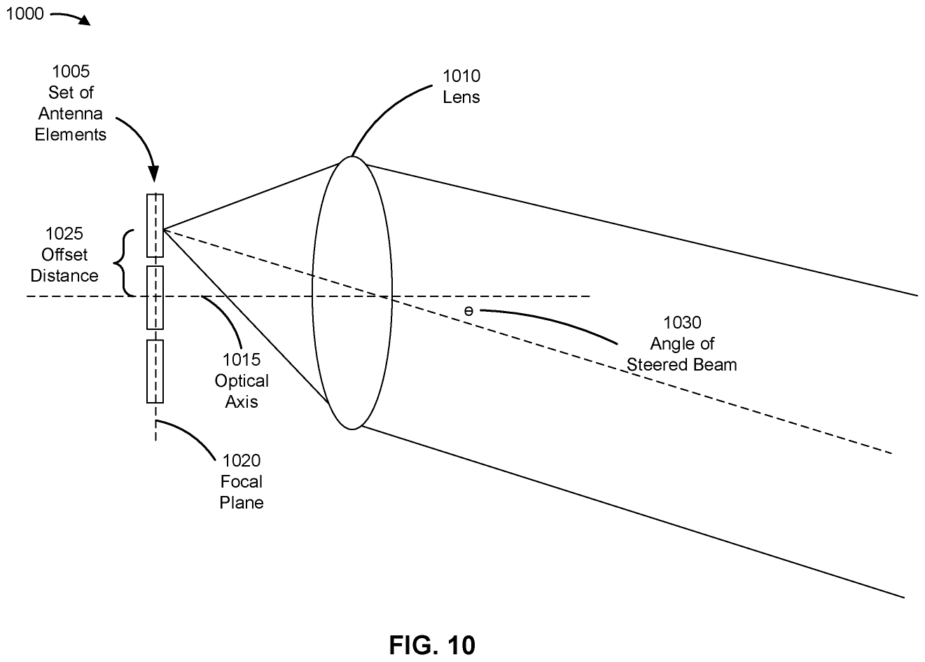

As shown in FIG. 10, example 1000 includes a set of antenna elements 1005 and a steering lens 1010. The steering lens 1010 may be an example of one of the steering lenses of any of FIGS. 5-8 and the antenna elements 1005 may be examples of the antenna elements associated with that steering lens from FIGS. 5-8. The set of antenna elements 1005 may be spaced from the steering lens along an optical axis 1015 such that the antenna elements 1005 are positioned on a focal plane 1020 (which may be flat or curved) of the steering lens 1010. Each antenna element of the set of antenna elements 1005 may be positioned along the focal plane at an offset distance (and direction) 1025. In some aspects, an antenna element of the set of antenna elements 1005 (e.g., the antenna element in the middle in FIG. 10) may be positioned with an offset distance of 0 (zero). As shown, when an antenna element of the set of antenna elements emits a signal, the signal may enter the steering lens 110, which may focus the signal into a steered beam that is a coherent, highly directional beam. The steered beam may have an angle 1030 that is based at least in part on the offset distance and direction. For example, the angle 1030 of the steered beam may be calculated using Equation 1, where the offset distance may have a positive or negative value to indicate direction:

tan θ=(offset distance)/(focal length) Equation 1

In some aspects, one or more antenna elements are aligned with a lens when their boresights intersect that lens, as illustrated in FIG. 10. In some aspects, a transmitter device may use a hybrid phased-array and steering lens beam steering as shown in FIGS. 5-10 when a wavelength of a data signal is significantly less than a steering lens diameter and a focal length of the steering lens. The transmitter device may use hybrid phased-array and steering lens beam steering to form a tight beam from a wide-angled antenna element.

As indicated above, FIGS. 5-10 are provided as examples. Other examples may differ from what is described with regard to FIGS. 5-10.

FIG. 11 is a diagram illustrating an example process 1100 performed, for example, by a wireless communication device, in accordance with various aspects of the present disclosure. Example process 1100 is an example where the wireless communication device (e.g., base station 110, UE 120, CPE, and/or the like) performs operations associated with hybrid phased-array and steering lenses for beam steering.

As shown in FIG. 11, in some aspects, process 1100 may include selecting, for communicating a signal, one or more active elements of a set of antenna elements based at least in part on positions of the one or more active elements of the set of antenna elements relative to a set of steering lenses of the wireless communication device (block 1110). For example, the wireless communication device (e.g., e.g., using controller/processor 240, transmit processor 220, TX MIMO processor 230, MOD 232, antenna 234, controller/processor 280, transmit processor 264, TX MIMO processor 266, MOD 254, antenna 252, and/or the like) may select, for communicating a signal, one or more active elements of a set of antenna elements based at least in part on positions (e.g., distance and/or direction from an optical axis) of the set of antenna elements relative to a set of steering lenses of the wireless communication device, as described above.

As further shown in FIG. 11, in some aspects, process 1100 may include communicating the signal based at least in part on emitting or receiving the signal using the one or more active elements, wherein the set of steering lenses of the wireless communication device steer the signal to or from the one or more active elements (block 1120). For example, the wireless communication device (e.g., e.g., using controller/processor 240, transmit processor 220, TX MIMO processor 230, MOD 232, antenna 234, controller/processor 280, transmit processor 264, TX MIMO processor 266, MOD 254, antenna 252, and/or the like) may communicate the signal based at least in part on emitting or receiving the signal using the one or more active elements, wherein the set of steering lenses of the wireless communication device steer the signal to or from the one or more active elements, as described above.

Process 1100 may include additional aspects, such as any single aspect or any combination of aspects described below and/or in connection with one or more other processes described elsewhere herein.

In a first aspect, the set of steering lenses are fixed relative to the set of antenna elements.

In a second aspect, alone or in combination with the first aspect, setting of antenna elements of the set of antenna elements are positioned along a focal plane of at least one of the set of steering lenses.

In a third aspect, alone or in combination with one or more of the first and second aspects, the set of steering lenses comprises one or more spherical lenses, one or more aspherical lenses, one or more single element lenses, one or more multiple element lenses, or one or more graded index lenses.

In a fourth aspect, alone or in combination with one or more of the first through third aspects, process 1100 includes applying a set of phase shifts to the signal before providing the signal to the one or more active elements, or applying a set of phase shifts to the signal received from the one or more active elements.

In a fifth aspect, alone or in combination with one or more of the first through fourth aspects, process 1100 includes selecting coarse steering and fine tuning of a beam direction, wherein selecting the one or more active elements of the set of antenna elements is based at least in part on the coarse steering, and wherein applying the set of phase shifts to the signal is based at least in part on fine tuning the beam direction.

In a sixth aspect, alone or in combination with one or more of the first through fifth aspects, process 1100 includes selecting, for communicating an additional signal, one or more additional active elements of the set of antenna elements based at least in part on positions of the one or more additional active elements of the set of antenna elements relative to the set of steering lenses of the wireless communication device, and communicating the additional signal based at least in part on emitting or receiving the additional signal using the one or more additional active elements, wherein the set of steering lenses steers the additional signal to or from the one or more additional active elements.

In a seventh aspect, alone or in combination with one or more of the first through sixth aspects, communicating the additional signal comprises spatially multiplexing the signal with the additional signal, and wherein the one or more additional active elements include at least one active element that is not included in the one or more active elements.

In an eighth aspect, alone or in combination with one or more of the first through seventh aspects, communicating the signal comprises applying a first set of phase shifts to the signal before emitting or after receiving the signal via the one or more active elements, and wherein communicating the additional signal comprises applying a second set of phase shifts to the additional signal before emitting or after receiving the additional signal via the one or more additional active elements.

In a ninth aspect, alone or in combination with one or more of the first through eighth aspects, applying the first set of phase shifts comprises providing the signal through one or more analog phase shifters, or wherein applying the second set of phase shifts comprises providing the additional signal through the one or more analog phase shifters.

In a tenth aspect, alone or in combination with one or more of the first through ninth aspects, applying the first set of phase shifts comprises providing the signal through a first set of digital phase shifters, or wherein applying the second set of phase shifts comprises providing the additional signal through a second set of digital phase shifters.

In an eleventh aspect, alone or in combination with one or more of the first through tenth aspects, process 1100 includes communicating with an additional wireless communication device via multiple beams generated based at least in part on providing the signal through the first set of digital phase shifters and emitting or receiving the signal via the one or more active elements, wherein the set of steering lenses steers the signal to or from the one or more active elements.

In a twelfth aspect, alone or in combination with one or more of the first through eleventh aspects, applying the first set of phase shifts comprises providing the signal through a first Butler matrix, or wherein applying the second set of phase shifts comprises providing the additional signal through a second Butler matrix.

In a thirteenth aspect, alone or in combination with one or more of the first through twelfth aspects, process 1100 includes communicating with an additional wireless communication device via multiple beams generated based at least in part on providing the signal through the first Butler matrix and emitting or receiving the signal using the one or more active elements, wherein the set of steering lenses steers the signal to or from the one or more active elements.

Although FIG. 11 shows example blocks of process 1100, in some aspects, process 1100 may include additional blocks, fewer blocks, different blocks, or differently arranged blocks than those depicted in FIG. 11. Additionally, or alternatively, two or more of the blocks of process 1100 may be performed in parallel.

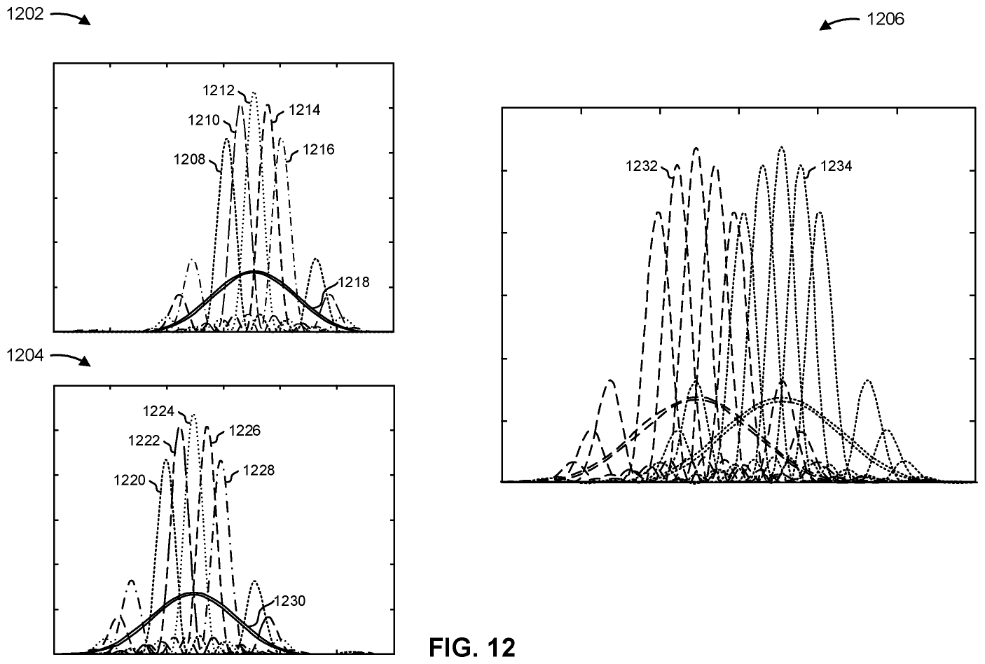

FIG. 12 is a diagram illustrating example power densities of signaling transmitted using a hybrid phased-array and steering lenses for beam steering, in accordance with the present disclosure. As shown in FIG. 12, diagrams 1202 and 1204 illustrate sets of power densities as observed by a receiver device at different directions from a transmitter device that is transmitting signals using a hybrid phased-array and steering lenses for beam steering. Diagram 1206 illustrates sets of power densities as observed by a receiver device at different directions from a transmitter device that is simultaneously transmitting multiple streams using disjoint antenna elements of a hybrid phased-array and multiple steering lenses for beam steering.

As shown in diagram 1202, signaling using a first respective antenna element associated with each steering lens may include multiple narrow, fine-tuned beams 1208, 1210, 1212, 1214, and/or 1216 based at least in part on applying different phase shifting to the antenna elements. A wide beam 1218 transmitted via the first respective antenna elements without fine tuning using phase shifting is shown having a wider range of directions, but with a lower peak power density than the fine-tuned beams 1208, 1210, 1212, 1214, and 1216. The transmitter device may select the beam 1218 to communicate with multiple UEs or to communicate with a single UE that has a high mobility, among other examples. The transmitter device may use one or more of the fine-tuned beams 1208, 1210, 1212, 1214, and 1216 to communicate with a UE that would benefit from an increased power density, such as a UE that is in a high-interference environment or a UE that is at an edge of coverage of the transmitter device, among other examples.

As shown in diagram 1204, signaling using a second respective antenna element associated with each steering lens may include multiple narrow, fine-tuned beams 1220, 1222, 1224, 1226, and/or 1228 based at least in part on applying different phase shifting to the antenna elements. A wide beam 1230 transmitted via the second respective antenna elements without fine tuning using phase shifting is shown having a wider range of directions, but with a lower peak power density than the fine-tuned beams 1220, 1222, 1224, 1226, and 1228. The transmitter device may select the beam 1230 to communicate with multiple UEs or to communicate with a single UE that has a high mobility, among other examples. The transmitter device may use one or more of the fine-tuned beams 1208, 1210, 1212, 1214, and 1216 to communicate with a UE that would benefit from an increased power density, such as a UE that is in a high-interference environment or a UE that is at an edge of coverage of the transmitter device, among other examples.

As shown in diagram 1206, signaling via both the first respective antenna elements and the second respective antenna elements may include sets 1232 and 1234 of narrow, fine-tuned beams and wide beams. For example, the set 1232 may include the fine-tuned beams 1208, 1210, 1212, 1214, and 1216 and the wide beam 1218 and the set 1234 may include the fine-tuned beams 1220, 1222, 1224, 1226, and 1228 and the wide beam 1230. As shown in diagram 1206, the transmitter device may select a beam from the set 1232 or the set 1234 to transmit signaling to a receiver device at any location along a relatively wide angle (e.g., may continuously steer a beam in a range of approximately 24 degrees to either side). This example utilizes four lenses. The angle/range over which the beams can be steered may increase with an increasing number of lenses, and the number of fine-tuned beams may increase with an increasing number of antenna elements (and increasing offset positions) associated with each lens. In some aspects, the transmitter device may communicate with multiple receiver devices using different fine tuned beams of the sets 1232 and/or 1234.

As indicated above, FIG. 12 is provided as an example. Other examples may differ from what is described with regard to FIG. 12.

The following provides an overview of some Aspects of the present disclosure:

Aspect 1: A method of wireless communication performed by a wireless communication device, comprising: selecting, for communicating a signal, one or more active elements of a set of antenna elements based at least in part on positions of the one or more active elements of the set of antenna elements relative to a set of steering lenses of the wireless communication device; and communicating the signal based at least in part on emitting or receiving the signal using the one or more active elements, wherein the set of steering lenses of the wireless communication device steer the signal to or from the one or more active elements.

Aspect 2: The method of Aspect 1, wherein the set of steering lenses are fixed relative to the set of antenna elements.

Aspect 3: The method of any of Aspects 1-2, wherein the set of antenna elements are positioned along a focal plane of at least one of the set of steering lenses.

Aspect 4: The method of any of Aspects 1-3, wherein the set of steering lenses comprises: one or more spherical lenses, one or more aspherical lenses, one or more single element lenses, one or more multiple element lenses, or one or more graded index lenses.

Aspect 5: The method of any of Aspects 1-4, further comprising: applying a set of phase shifts to the signal before providing the signal to the one or more active elements, or applying a set of phase shifts to the signal received from the one or more active elements.

Aspect 6: The method of Aspect 5, further comprising: selecting coarse steering and fine tuning of a beam direction, wherein selecting the one or more active elements of the set of antenna elements is based at least in part on the coarse steering, and wherein applying the set of phase shifts to the signal is based at least in part on fine tuning the beam direction.

Aspect 7: The method of any of Aspects 1-6, further comprising: selecting, for communicating an additional signal, one or more additional active elements of the set of antenna elements based at least in part on positions of the one or more additional active elements of the set of antenna elements relative to the set of steering lenses of the wireless communication device; and communicating the additional signal based at least in part on emitting or receiving the additional signal using the one or more additional active elements, wherein the set of steering lenses steers the additional signal to or from the one or more additional active elements .

Aspect 8: The method of Aspect 7, wherein communicating the additional signal comprises spatially multiplexing the signal with the additional signal, and wherein the one or more additional active elements include at least one active element that is not included in the one or more active elements.

Aspect 9: The method of any of Aspects 7-8, wherein communicating the signal comprises applying a first set of phase shifts to the signal before emitting or after receiving the signal via the one or more active elements, and wherein communicating the additional signal comprises applying a second set of phase shifts to the additional signal before emitting or after receiving the additional signal via the one or more additional active elements.

Aspect 10: The method of Aspect 9, wherein applying the first set of phase shifts comprises providing the signal through one or more analog phase shifters, or wherein applying the second set of phase shifts comprises providing the additional signal through the one or more analog phase shifters.

Aspect 11: The method of Aspect 9, wherein applying the first set of phase shifts comprises providing the signal through a first set of digital phase shifters, or wherein applying the second set of phase shifts comprises providing the additional signal through a second set of digital phase shifters.

Aspect 12: The method of Aspect 11, further comprising: communicating with an additional wireless communication device via multiple beams generated based at least in part on providing the signal through the first set of digital phase shifters and emitting or receiving the signal via the one or more active elements, wherein the set of steering lenses steers the signal to or from the one or more active elements.

Aspect 13: The method of Aspect 9, wherein applying the first set of phase shifts comprises providing the signal through a first Butler matrix, or wherein applying the second set of phase shifts comprises providing the additional signal through a second Butler matrix.

Aspect 14: The method of Aspect 13, further comprising: communicating with an additional wireless communication device via multiple beams generated based at least in part on providing the signal through the first Butler matrix and emitting or receiving the signal using the one or more active elements, wherein the set of steering lenses steers the signal to or from the one or more active elements.

Aspect 15: An apparatus for wireless communication at a device, comprising a processor; memory coupled with the processor; and instructions stored in the memory and executable by the processor to cause the apparatus to perform the method of one or more of Aspects 1-14.

Aspect 16: A device for wireless communication, comprising a memory and one or more processors coupled to the memory, the one or more processors configured to perform the method of one or more of Aspects 1-14.

Aspect 17: An apparatus for wireless communication, comprising at least one means for performing the method of one or more of Aspects 1-14.

Aspect 18: A non-transitory computer-readable medium storing code for wireless communication, the code comprising instructions executable by a processor to perform the method of one or more of Aspects 1-14.

Aspect 19: A non-transitory computer-readable medium storing a set of instructions for wireless communication, the set of instructions comprising one or more instructions that, when executed by one or more processors of a device, cause the device to perform the method of one or more of Aspects 1-14.

Aspect 20: An apparatus for wireless communication, comprising: an array of lenses; multiple pluralities of antenna elements, wherein a respective plurality of the multiple pluralities of antenna elements is aligned with each lens in the array of lenses; and; transceiver circuitry configured to transmit or receive wireless signals through the array of lenses using at least a subset of antenna elements in each plurality of antenna elements.

Aspect 21: The apparatus of Aspect 20, wherein respective antenna elements of each plurality of antenna elements collectively form a phased array.

Aspect 22: The apparatus of Aspect 21, further comprising analog or digital phase shifters or a Butler matrix coupled to the respective antenna elements.

Aspect 23: The apparatus of any of Aspects 20-22, wherein the array of lenses comprises four or more lenses.

Aspect 24: The apparatus of any of Aspects 20-23, wherein each plurality of antenna elements comprises three or more antenna elements.

The foregoing disclosure provides illustration and description, but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a processor is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods were described herein without reference to specific software code—it being understood that software and hardware can be designed to implement the systems and/or methods based, at least in part, on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. In fact, many of these features may be combined in ways not specifically recited in the claims and/or disclosed in the specification. Although each dependent claim listed below may directly depend on only one claim, the disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A wireless communication device for wireless communication, comprising:
a set of antenna elements;
a set of steering lenses;
a memory; and
one or more processors operatively coupled to the memory, the memory and the one or more processors configured to:
select, for communicating a signal, one or more active elements of the set of antenna elements based at least in part on positions of the one or more active elements of the set of antenna elements relative to the set of steering lenses; and
communicate the signal based at least in part on emitting or receiving the signal using the one or more active elements, wherein the set of steering lenses steers the signal to or from the one or more active elements.

2. The wireless communication device of claim 1,
wherein the set of steering lenses are fixed relative to the set of antenna elements.

3. The wireless communication device of claim 1,
wherein antenna elements of the set of antenna elements are positioned along a focal plane of at least one of the set of steering lenses.

4. The wireless communication device of claim 1, wherein the set of steering lenses comprises:
one or more spherical lenses,
one or more aspherical lenses,
one or more single element lenses,
one or more multiple element lenses, or
one or more graded index lenses.

5. The wireless communication device of claim 1, wherein the one or more processors are further configured to:
apply a set of phase shifts to the signal before providing the signal to the one or more active elements, or
apply a set of phase shifts to the signal received from the one or more active elements.

6. The wireless communication device of claim 5, wherein the one or more processors are further configured to:
select coarse steering and fine tuning of a beam direction,
wherein the one or more active elements of the set of antenna elements are selected based at least in part on the coarse steering, and
wherein the set of phase shifts are applied to the signal based at least in part on fine tuning of the beam direction.

7. The wireless communication device of claim 1, wherein the one or more processors are further configured to:
select, for communication of an additional signal, one or more additional active elements of the set of antenna elements based at least in part on positions of the one or more additional active elements of the set of antenna elements relative to the set of steering lenses; and
communicate the additional signal based at least in part on emitting or receiving the additional signal using the one or more additional active elements, wherein the set of steering lenses steers the additional signal to or from the one or more additional active elements.

8. The wireless communication device of claim 7,
wherein communication of the additional signal comprises spatially multiplexing the signal with the additional signal, and
wherein the one or more additional active elements include at least one active element that is not included in the one or more active elements.

9. The wireless communication device of claim 7,
wherein communication of the signal comprises applying a first set of phase shifts to the signal before emitting or after receiving the signal via the one or more active elements, and
wherein communication of the additional signal comprises applying a second set of phase shifts to the additional signal before emitting or after receiving the additional signal via the one or more additional active elements.

10. The wireless communication device of claim 9,
wherein application of the first set of phase shifts comprises providing the signal through one or more analog phase shifters, or
wherein application of the second set of phase shifts comprises providing the additional signal through the one or more analog phase shifters.

11. The wireless communication device of claim 9,
wherein application of the first set of phase shifts comprises providing the signal through a first set of digital phase shifters, or
wherein application of the second set of phase shifts comprises providing the additional signal through a second set of digital phase shifters.

12. The wireless communication device of claim 11, wherein the one or more processors are further configured to:
communicate with an additional wireless communication device via multiple beams generated based at least in part on providing the signal through the first set of digital phase shifters and emitting or receiving the signal via the one or more active elements, wherein the set of steering lenses steers the signal to or from the one or more active elements.

13. The wireless communication device of claim 9,
wherein application of the first set of phase shifts comprises providing the signal through a first Butler matrix, or
wherein application of the second set of phase shifts comprises providing the additional signal through a second Butler matrix.

14. The wireless communication device of claim 13, wherein the one or more processors are further configured to:
communicate with an additional wireless communication device via multiple beams generated based at least in part on providing the signal through the first Butler matrix and emitting or receiving the signal using the one or more active elements, wherein the set of steering lenses steers the signal to or from the one or more active elements.

15. A method of wireless communication performed by a wireless communication device, comprising:
selecting, for communicating a signal, one or more active elements of a set of antenna elements based at least in part on positions of the one or more active elements of the set of antenna elements relative to a set of steering lenses of the wireless communication device; and
communicating the signal based at least in part on emitting or receiving the signal using the one or more active elements, wherein the set of steering lenses of the wireless communication device steer the signal to or from the one or more active elements.

16. The method of claim 15, wherein the set of antenna elements are positioned along a focal plane of at least one of the set of steering lenses.

17. The method of claim 15, further comprising:
applying a set of phase shifts to the signal before providing the signal to the one or more active elements, or
applying a set of phase shifts to the signal received from the one or more active elements.

18. The method of claim 17, further comprising:
selecting coarse steering and fine tuning of a beam direction,
wherein selecting the one or more active elements of the set of antenna elements is based at least in part on the coarse steering, and
wherein applying the set of phase shifts to the signal is based at least in part on fine tuning the beam direction.

19. The method of claim 15, further comprising:
selecting, for communicating an additional signal, one or more additional active elements of the set of antenna elements based at least in part on positions of the one or more additional active elements of the set of antenna elements relative to the set of steering lenses of the wireless communication device; and
communicating the additional signal based at least in part on emitting or receiving the additional signal using the one or more additional active elements, wherein the set of steering lenses steers the additional signal to or from the one or more additional active elements .

20. The method of claim 19, wherein communicating the additional signal comprises spatially multiplexing the signal with the additional signal, and
wherein the one or more additional active elements include at least one active element that is not included in the one or more active elements.

21. The method of claim 19, wherein communicating the signal comprises applying a first set of phase shifts to the signal before emitting or after receiving the signal via the one or more active elements, and
wherein communicating the additional signal comprises applying a second set of phase shifts to the additional signal before emitting or after receiving the additional signal via the one or more additional active elements.

22. The method of claim 21, wherein applying the first set of phase shifts comprises providing the signal through one or more analog phase shifters, or
wherein applying the second set of phase shifts comprises providing the additional signal through the one or more analog phase shifters.

23. The method of claim 21, wherein applying the first set of phase shifts comprises providing the signal through a first Butler matrix, or
wherein applying the second set of phase shifts comprises providing the additional signal through a second Butler matrix.

24. The method of claim 23, further comprising:
communicating with an additional wireless communication device via multiple beams generated based at least in part on providing the signal through the first Butler matrix and emitting or receiving the signal using the one or more active elements, wherein the set of steering lenses steers the signal to or from the one or more active elements.

25. An apparatus for wireless communication, comprising:
means for selecting, for communicating a signal, one or more active elements of a set of antenna elements based at least in part on positions of the one or more active elements of the set of antenna elements relative to a set of steering lenses of the apparatus; and
means for communicating the signal based at least in part on emitting or receiving the signal using the one or more active elements, wherein the set of steering lenses of the apparatus steer the signal to or from the one or more active elements.

26. An apparatus for wireless communication, comprising:
an array of lenses;
multiple pluralities of antenna elements, wherein a respective plurality of the multiple pluralities of antenna elements is aligned with each lens in the array of lenses; and
transceiver circuitry configured to transmit or receive wireless signals through the array of lenses using at least a subset of antenna elements in each plurality of antenna elements.

27. The apparatus of claim 26, wherein respective antenna elements of each plurality of antenna elements collectively form a phased array.

28. The apparatus of claim 27, further comprising analog or digital phase shifters or a Butler matrix coupled to the respective antenna elements.

29. The apparatus of claim 26, wherein the array of lenses comprises four or more lenses.

30. The apparatus of claim 29, wherein each plurality of antenna elements comprises three or more antenna elements.
